(19) United States
(12) Patent Application Publication
(10) Pub. No.: US 2009/0172029 A1
(43) Pub. Date: Jul. 2, 2009

(54) REMOTE MANAGING AND CONSULTING SYSTEM FOR LOGISTICS

(75) Inventor: Liying GENG, Beijing (CN)

Correspondence Address: YING CHEN;Chen Yoshimura LLP, 255 S. GRAND AVE., # 215, LOS ANGELES, CA, 90012, US

(73) Assignee: Beijing Aotengxunda Science and Technology Co., Ltd, Beijing, CA (US)

(21) Appl. No.: 12/119,750

(22) Filed: May 13, 2008

(30) Foreign Application Priority Data
Dec. 27, 2007 (CN) 200710304385.0

(51) Int. Cl. G06F 17/30

(52) U.S. Cl. 707/104.1; 707/E17.009

(57) ABSTRACT

This invention relates to A remote managing and consulting system for logistics comprising a central processing system and one or more remote terminals which exchange data with the central processing system, wherein each of the remote terminals includes a wireless transmitting and receiving module, a optimization unit for logistics organization of the central processing system will generate optimization plans for transporting organization, an individuation optimization unit for logistics plans of the central processing system will generate optimization plans for individuation transporting. This invention is favorable to improve logistics efficiency, reduce logistics time and decrease logistics costs.

### BACKGROUND OF THE INVENTION

1. Field of the Invention

This invention relates to a remote managing and consulting system for logistics, belonging to computer information technology field.

2. Description of the Related Art

Most application software in domestic logistics mainly focuses on single link business process and deals with transport management, storage management and other application system. The optimization of logistics usually emphasis on theory research and fails to provide strong optimization software to support logistics network optimization, logistics organization optimization, logistics plan compilation, logistics plan evaluation and logistics cost analysis. The optimization technology of logistics in some area is comparatively mature, however, it is difficult for abroad software to use directly in domestic enterprises because of the complicated and different domestic environment.

### SUMMARY OF THE INVENTION

To overcome the above disadvantages of the existed technology, the present invention provides a remote managing and consulting system for logistics, which can carry out optimization analyses and processing of logistics to realize best logistics plans.

To achieve the above purposes, the present invention uses the following technical solution: a remote managing and consulting system for logistics mainly comprising a central processing system and one or more remote terminals which exchange data with the central processing system, wherein each of the remote terminals includes a wireless transmitting and receiving module for wireless communication with the central processing system via wireless base stations, wherein the central processing system includes a matching wireless transmitting and receiving module, a logistics basic database, a real time database, an information inquiry unit, an optimization unit for logistics network, an optimization unit for logistics organization and an individuation optimization unit for logistics plans, wherein matching wireless transmitting and receiving module is used for receiving data sent by the remote terminal via wireless base stations, wherein the information inquiry unit reads data in the logistics basic database and the real time database according to inquiry information inputted manually via a remote terminal and displays these data on a monitor, wherein the optimization unit for logistics network reads the data in the logistics basic database according to logistics information inputted manually via a remote terminal and carries out an optimization operation to generate optimization plans for transporting network, wherein the optimization unit for logistics organization reads the data in the logistics basic database and in the real time database according to logistics information inputted manually via a remote terminal and carries out an optimization operation to generate optimization plans for transporting organization, wherein the individuation optimization unit for logistics plans reads the data in the logistics basic database and in the real time database according to logistics information inputted manually via a remote terminal and carries out an optimization operation to generate optimization plans for individuation transporting.

This invention can provide all kinds of logistics data to the remote terminal via wireless communication and carry out optimization plans for logistics network, for logistics organization, for individuation logistics plans. This is very favorable for logistics plan design and selecting, for improving logistics efficiency, reducing logistics time, decreasing logistics cost and thus improving the economic operations efficiency of the whole society.

### BRIEF DESCRIPTION OF THE DRAWINGS

FIG. 1 is a structural scheme of this invention.

### DETAILED DESCRIPTION OF THE PREFERRED EMBODIMENTS

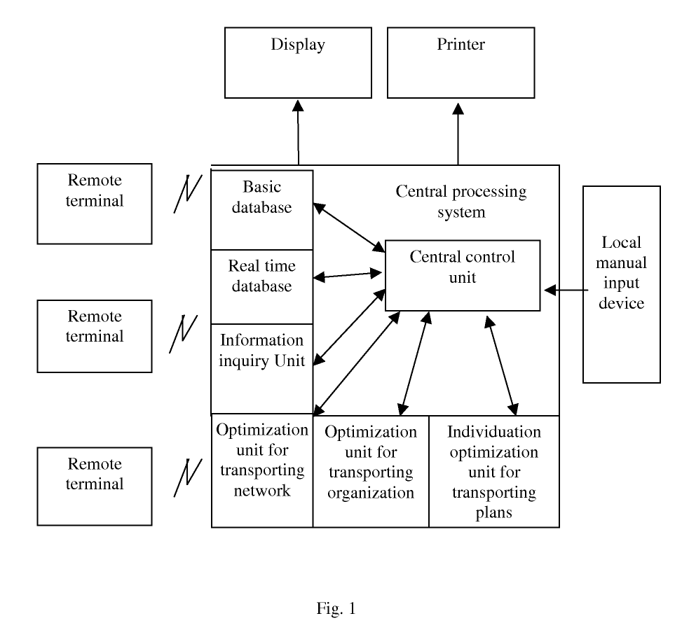

As shown in FIG. 1, the remote managing and consulting system for logistics mainly comprising a central processing system and one or more remote terminals which exchange data with the central processing system, wherein each of the remote terminals includes a wireless transmitting and receiving module for wireless communication with the central processing system via wireless base stations, wherein the central processing system includes a matching wireless transmitting and receiving module, a logistics basic database, a real time database, an information inquiry unit, an optimization unit for logistics network, an optimization unit for logistics organization and an individuation optimization unit for logistics plans, wherein matching wireless transmitting and receiving module is used for receiving data sent by the remote terminal via wireless base stations, wherein the information inquiry unit reads data in the logistics basic database and the real time database according to inquiry information inputted manually via a remote terminal and displays these data on a monitor, wherein the optimization unit for logistics network reads the data in the logistics basic database according to logistics information inputted manually via a remote terminal and carries out an optimization operation to generate optimization plans for transporting network, wherein the optimization unit for logistics organization reads the data in the logistics basic database and in the real time database according to logistics information inputted manually via a remote terminal and carries out an optimization operation to generate optimization plans for transporting organization, wherein the individuation optimization unit for logistics plans reads the data in the logistics basic database and in the real time database according to logistics information inputted manually via a remote terminal and carries out an optimization operation to generate optimization plans for individuation transporting.

The logistics basic database and real time database can automatically regulate and maintain relevant logistics data according to manual input, including the maintenance of administrative division data, which provides information coding for cities at or above the county level according to national administrative division as well as data increasing, deleting and amending. The maintenance of transporting network dada offers information coding for railway network, highway network between cities at or above the county level, airlines as well as data increasing, deleting and amending. The maintenance of enterprise operating institutes data provides information description for geography, organization and business range of enterprise management institutes, transport nodes, storage nodes, dispatching nodes, operating nodes and transporting networks, as well as data increasing, deleting and amending. The maintenance of enterprise logistics resource data offers information description for railway goods transport resource, highway transport resource and airline transport resource as well as data increasing, deleting and amending.

The information inquiry unit can automatically read the data in database according to outside inputted instructions and information requirements meanwhile display or dialog via monitoring system, including inquiry of administrative division information, which offers conditional searching for information of existed cities at or above county level in database; inquiry of railway, highway and airline, which provide searching for existed railway network, highway network between cities at or above county level and airline transport network; inquiry of enterprise logistics resource, where the enterprises can carry out information inquiry via the transport network formed by railway, highway, airline transporting resource as well as transport nodes, storage nodes, dispatching nodes, operating nodes of the enterprises; inquiry of logistics plans, which offers the searching of existed transport plans in products of enterprise supply routes; inquiry of transport charge for railway, highway and airlines between cities, which provides calculation of point-to-point standard prices for different transport manner according to the regulations of state authority and the charging policy of enterprises.

The optimization unit for logistics network can carry out relevant optimization plan design according to the manually inputted optimization requirements and basic data. It covers analysis and forecast of logistics demand, which can provide potential forecast for development of future logistics business according to the analysis of past logistics data and combining demand change of home logistics market, help the enterprises to perform relevant evaluations for transport demand and the capacity of transport network, used as quantifiable basis of the optimization; according to the analysis of goods storage in enterprise logistics nodes and past throughput data, the optimization of logistics node layout can provide evaluations for point-to point operation effects, meanwhile combined with logistics demand forecast, evaluate the bottleneck of logistics nodes, which can help the enterprises with overall optimization of nodes layout; optimization selection of transport manner between logistics nodes will evaluate flux layout of different transport manner and transport resource utilization according to the analysis of goods flux of different transport manner as well as the bearing capacity, meantime offer choices for low cost transport manner that satisfies transport requirements according to costs of different transport manners.

The optimization unit for logistics organization can carry out relevant optimization plan design according to the manually inputted optimization requirements and basic data. It includes the automatic generation and management of the route of single transportation between logistics nodes, provides through or multilevel transshipment transport plans of single railway, highway, and airline transportation between logistics nodes and automatically calculates the punctuality of each plan as well as basic costs meanwhile the plans can be ordered, selected and support manual regulation, and the automatic generation and management of linked route of the integrated transportation between logistics nodes offers automatic generation of linked transport plans of railway, highway, and airline transportation between logistics nodes as well as automatically calculates the punctuality of each plan as well as basic costs meanwhile the plans can be ordered, selected and support manual regulation; profit and loss balance analysis of transport routs between logistics nodes, the system can automatically carry out profit and loss balance analysis according to operating cost and past profits of different transport routs between logistics nodes; based on the transport plans of single or multilevel transportation and calculation of plan punctuality and cost, combined with the analysis results of transport resource, optimization of logistics organization provides optimizing basis and reference plans for transport network and organization; adaptability analysis of logistics network capacity, the system will evaluate the capacity of logistics network to market demand according to forecast of enterprise logistics demand and available transport plan.

The individuation optimization unit for logistics plans can carry out relevant optimization plan design according to the manually inputted optimization requirements and basic data. It includes automatic generation of client logistics plans, which can automatically generate many kinds of transport plans based on the clients' punctuality and quality requirements for them to choose, and manual regulation and management of client logistics plans, for the plans automatically generated by the system, the system supports manual regulation if needed, and cost analysis of client logistics plans, the system will provide basic calculation of transport plan unit cost at the same time of transport plan generation, which is convenient for the enterprises to make transport prices, and quotation management of client logistics plans, the system haves data management function of transport plan unit cost and client price, which is favorable for the market department to negotiate with other clients, to maintain enterprise price system as well as market price steady to guarantee profits.

It will be apparent to those skilled in the art that various modification and variations can be made in the device of the present invention without departing from the spirit or scope of the invention. Thus, it is intended that the present invention cover modifications and variations that come within the scope of the appended claims and their equivalents.

What is claimed is:

1. A remote managing and consulting system for logistics, comprising:
a central processing system; and
one or more remote terminals which exchange data with the central processing system,
wherein each of the remote terminals includes a wireless transmitting and receiving module for wireless communication with the central processing system via wireless base stations,
wherein the central processing system includes a corresponding wireless transmitting and receiving module, a logistics basic database, a real time database, an information inquiry unit, an optimization unit for logistics network, an optimization unit for logistics organization and an individuation optimization unit for logistics plans,
wherein the wireless transmitting and receiving module of the central processing system receives data sent by the remote terminal via wireless base stations,
wherein the information inquiry unit reads data in the logistics basic database and the real time database according to inquiry information inputted manually via a remote terminal and displays these data on a monitor,
wherein the optimization unit for logistics network reads the data in the logistics basic database according to logistics information inputted manually via a remote terminal and carries out an optimization operation to generate optimization plans for transporting network,
wherein the optimization unit for logistics organization reads the data in the logistics basic database and in the real time database according to logistics information inputted manually via a remote terminal and carries out an optimization operation to generate optimization plans for transporting organization, and
wherein the individuation optimization unit for logistics plans reads the data in the logistics basic database and in the real time database according to logistics information inputted manually via a remote terminal and carries out an optimization operation to generate optimization plans for individuation transporting.

2. The system of claim 1, wherein the logistics basic database and the real time database automatically regulate and maintain relevant logistics data and administrative division data according to data inputted manually via a remote terminal.

3. The system of claim 2, wherein the logistics basic database and the real time database automatically regulate and maintain transporting network dada according to data inputted manually via a remote terminal.

4. The system of claim 3, wherein the logistics basic database and the real time database automatically regulate and maintain enterprise data according to data inputted manually via a remote terminal.

5. The system of claim 4, wherein the logistics basic database and the real time database automatically regulate and maintain enterprise logistics resource data according to data inputted manually via a remote terminal.

6. The system of claim 5, wherein the information inquiry unit automatically reads the data in the databases according to instructions and information requirements inputted manually via a remote terminal, displays the data via a monitoring system, makes conditional searching in the logistics basic database and in the real time database for the information of cities, railway network, highway network, airline transport network and enterprise logistics resource and gives a point-to-point standard prices of different transport plans based on the information searched.

7. The system of claim 1, wherein the logistics basic database and the real time database automatically regulate and maintain transporting network dada according to data inputted manually via a remote terminal.

8. The system of claim 7, wherein the logistics basic database and the real time database automatically regulate and maintain enterprise data according to data inputted manually via a remote terminal.

9. The system of claim 8, wherein the logistics basic database and the real time database automatically regulate and maintain enterprise logistics resource data according to data inputted manually via a remote terminal.

10. The system of claim 9, wherein the information inquiry unit automatically reads the data in the databases according to instructions and information requirements inputted manually via a remote terminal, displays the data via a monitoring system, makes conditional searching in the logistics basic database and in the real time database for the information of cities, railway network, highway network, airline transport network and enterprise logistics resource and gives a point-to-point standard prices of different transport plans based on the information searched.

11. The system of claim 1, wherein the logistics basic database and the real time database automatically regulate and maintain enterprise data according to data inputted manually via a remote terminal.

12. The system of claim 11, wherein the logistics basic database and the real time database automatically regulate and maintain enterprise logistics resource data according to data inputted manually via a remote terminal.

13. The system of claim 12, wherein the information inquiry unit automatically reads the data in the databases according to instructions and information requirements inputted manually via a remote terminal, displays the data via a monitoring system, makes conditional searching in the logistics basic database and in the real time database for the information of cities, railway network, highway network, airline transport network and enterprise logistics resource and gives a point-to-point standard prices of different transport plans based on the information searched.

14. The system of claim 1, wherein the logistics basic database and the real time database automatically regulate and maintain enterprise logistics resource data according to data inputted manually via a remote terminal.

15. The system of claim 14, wherein the information inquiry unit automatically reads the data in the databases according to instructions and information requirements inputted manually via a remote terminal, displays the data via a monitoring system, makes conditional searching in the logistics basic database and in the real time database for the information of cities, railway network, highway network, airline transport network and enterprise logistics resource and gives a point-to-point standard prices of different transport plans based on the information searched.

16. The system of claim 1, wherein the information inquiry unit automatically reads the data in the databases according to instructions and information requirements inputted manually via a remote terminal, displays the data via a monitoring system, makes conditional searching in the logistics basic database and in the real time database for the information of cities, railway network, highway network, airline transport network and enterprise logistics resource and gives a point-to-point standard prices of different transport plans based on the information searched.
